(19) United States
(12) Patent Application Publication
(10) Pub. No.: US 2011/0185922 A1
(43) Pub. Date: Aug. 4, 2011

(54) PROTECTOR MEMBER FOR LIQUID IN A CONTAINER

(75) Inventor: Barry Maxwell Rees, Victoria (AU)

(73) Assignee: CREATED BY "BRAINWAVE" PTY LTD, Richmond, Victoria (AU)

(21) Appl. No.: 13/003,622

(22) PCT Filed: Jul. 10, 2009
(86) PCT No.: PCT/AU2009/000888

§ 371 Date: Apr. 19, 2011

(30) Foreign Application Priority Data
Jul. 16, 2008 (AU) 2008903621
May 26, 2009 (AU) 2009902383

(51) Int. Cl. C12H 1/00

(52) U.S. Cl. 99/645

(57) ABSTRACT

The specification discloses a protector member (10) capable of being introduced through a neck region (25) of an opened wine bottle (26) by being flexibly deformable, the protector member (10) being flexibly deformable to a condition enabling introduction through the wine bottle neck region (25) and once within the wine bottle (26) being expandable to a use condition where an outer peripheral edge (15, 62) of the protector member (10) is positioned adjacent to or against an inner surface of the wine bottle (26) while floating on a surface of wine held within the wine bottle (26), the protector member (10) being characterized by being either a multipart construction including a first flexible sheet (11, 19) material containing in a first zone (14) a plurality of individually sealed spaces (22) each having a volume and at least some of which contain a gas, and a second flexible sheet material (12, 19), one or both of the first or second flexible sheet materials having a radially outer edge (15) forming the outer peripheral edge of the protector member (10) extending radially beyond the first zone (14); or by being a continuous sheet member, the continuous sheet member (60) being composed of a cork or cork based material such as granulated cork bonded to form said sheet member (60); the protector member (10) being substantially liquid wine and gas impervious; the specification also discloses a device (27, 30) for introducing a protector member (10) as aforesaid into a wine bottle (26) the device (27, 30) having an outer flexible container (27) holding a said protector member (10) therein, the outer flexible container (27) being open or openable along at least a portion of two opposed edge regions (28, 29), the device (27, 30) further including a delivery member (30) capable of engaging and rolling the protector member (10) on itself within the outer flexible container (27) and to then insert the rolled protector member (10) through the wine bottle neck region (25) passing beyond one of said two opposed edge regions (28, 29) of the outer flexible container (27).

### FIELD OF THE INVENTION

The present disclosure relates to minimizing and/or retarding the degradation of liquid in a container by potential reaction with a gas such as air. Preferably but not exclusively, the disclosure relates to the minimizing and/or retarding of the degradation of wine in a bottle once opened to allow the wine to be consumed over a longer period of time.

### BACKGROUND OF THE INVENTION

There is a market for consuming wine by the glass, both domestically and on commercial premises, where the wine remaining in the bottle needs to be protected against degradation. Commercial premises such as restaurants, bars, hotels and the like desirably need a convenient and economic system for protecting the wine remaining in a bottle after it has been first opened and some wine has been dispensed, against speedy degradation in the bottle. The same requirement often exists in a home or domestic environment where a consumer may not wish to wholly consume a bottle of wine once initially opening the bottle.

There are a number of known arrangements that seek to preserve wine in an opened wine bottle which place a temporary stopper or seal in the bottle and evacuating air from the bottle above the remaining wine. These arrangements, while protecting the wine against degradation to some extent, may remove aromatic characteristics from the wine by the evacuation process. Other known arrangements include placing an inert gas such as nitrogen or argon into the bottle to displace the air therefrom. Such systems may be used alone or also with a temporary stopper or seal. Most known systems work reasonably well when an opened wine bottle is to be stored overnight, however, they are sufficiently complicated and costly to make their use problematic each time a glass of wine is poured from a bottle, whereby many commercial suppliers of wine by the glass and domestic (non commercial) users will not use them during a days operation. Thus wine can deteriorate during a day when a wine bottle has been opened and sufficient spoilage can occur to require an undesirable percentage of such wine to be discarded.

Australian patent specification no. 2005316912 discloses a barrier member that in use can be introduced into a bottle of wine that has been opened and had some wine dispensed therefrom. The barrier member is constructed of a number of different parts and is designed to enter the wine bottle through its neck region and to expand once in the bottle to float on the surface of the remaining wine in the bottle.

### SUMMARY OF THE INVENTION

Accordingly, it is an objective of the present invention to provide an improved barrier member for use with wine that remains in a bottle after the wine bottle is first opened that will be effective in minimizing wine deterioration as the remaining wine is consumed and will be less expensive to produce than known such barrier members. It is also a preferred objective to provide an improved method of storing such barrier members in a hygienic manner and to enable convenient introduction of such barrier members into an opened wine bottle when desired.

In accordance with one aspect of this invention, there is provided a protector member adapted, for use with liquid remaining in a bottle after some liquid has been dispensed therefrom, said protector member being formed in a first condition with an outer peripheral edge approximating internal cross-sectional dimensions of a body region of the bottle, said protector member being flexibly deformable to a second condition for introduction through a neck region of the bottle and once in said body region of the bottle is returned to said first condition and is disposed on a surface of the liquid remaining in said bottle, whereby air contact with the liquid remaining in the bottle is restricted, said protector member being characterized by being a multipart construction including a first flexible sheet material containing in a first zone, a plurality of individually substantially sealed spaces each having a volume and at least some of which contain a gas, and a second flexible sheet material, one or both of said first or said second flexible sheet materials having a radially outer edge forming the outer peripheral edge of said protector member, said radially outer edge extending radially beyond said first zone, at least one of said first or said second flexible sheet materials being substantially liquid and gas impervious. In one embodiment, the liquid is wine and the bottle is a wine bottle. Preferably, in the second condition, the outer peripheral edge of the protector member engages an inner surface of the wine bottle and is capable of moving vertically along the inner surface of the wine bottle as the level of wine in the bottle changes. Conveniently the protector member positioned on the remaining wine in the wine bottle minimizes any reaction of the wine with the gas entering the bottle that may cause degradation of the wine.

In a certain preferred embodiment the first flexible sheet material is substantially sealed to the second flexible sheet material to define said sealed spaces in said first zone. Conveniently a third flexible sheet material is positioned over said first flexible sheet material and secured to said first flexible sheet material, said second flexible sheet material or both said first and said second flexible sheet materials. Preferably at least both said second flexible sheet material is substantially liquid impervious and substantially gas impervious. Conveniently both the second and the third flexible sheet materials are substantially liquid and gas impervious.

In another preferred embodiment the first flexible sheet material may be sealed to said second flexible sheet material generally about said first zone to form said first zone as a sealed space, said first zone containing said individually sealed spaces. In this preferred embodiment, the individually sealed spaces may be formed by at least two further flexible sheet material layers sealed to one another. In this embodiment it is preferred that at least one or both the first and the second flexible sheet materials are substantially liquid impervious and gas impervious.

In the above discussed embodiments, reference to liquid impervious means includes that the material is substantially impervious to wine as a liquid. Moreover, it is preferred that the material that potentially will contact the wine surface in the opened wine bottle, be produced from a material that will not react with the wine. Conveniently the materials forming the protector member are plastic film materials that may be sealed to one another when a seal is required by any suitable means including heat sealing and adhesive materials. The gas in any of the above described individually sealed spaces will normally be air, however, it is equally possible to use an inert gas such as nitrogen or argon. It is further possible to introduce into some of the individually sealed spaces, a liquid or gel material to provide a weight when desired. Conveniently the individually sealed spaces containing liquid or a gel may be located closer to a peripheral region of the first zone with air or gas filling more centrally located such spaces.

It has been surprisingly found that providing structures as described herein, provide the protector member with sufficient floation or buoyancy while the individually sealed spaces while being capable of defining the second condition, provide urging forces that will enable the member to unroll or unfold to the first condition once it is free to do so in the opened wine bottle. Moreover, the assembly of the protector member can be readily automated and can be produced easily and inexpensively.

In another embodiment there is provided a device for minimizing reaction of a liquid in a container with a gas after the container is initially opened, said device comprising an outer flexible holder that is open or openable along at least a portion of two opposed edge regions, said flexible holder holding a protector member which in a first condition has an outer peripheral edge approximating internal cross-sectional dimensions of a body region of the container, said protector member being flexibly deformable to a second condition for introduction through a first region of the container permitting the liquid to be dispensed therethrough and once in said body region of the container is returned to said first condition to be located in a surface of the liquid in said container, said protector member being rollable while within said outer flexible holder into said second condition for introduction into said container through one of said edge regions of said outer flexible container and through said first region of the container.

In a further aspect, there is provided a device for minimizing wine degradation in a wine bottle after being initially opened, said device comprising an outer flexible container that is open or openable along at least a portion of two opposed edge regions, said flexible container holding a wine protector member which in a first condition has an outer peripheral edge approximating internal cross-sectional dimensions of a body region of the wine bottle, said wine protector member being flexibly deformable to a second condition for introduction through a neck region of the wine bottle and once in said body region of the wine bottle is returned to said first expanded condition to be located on a surface of wine in said body region, said wine protector member, in use, being rollable while within said outer flexible container about an axis extending between said two opposed edge regions for introduction into said opened wine bottle through one of said edge regions of said outer flexible container.

According to yet another aspect, there is provided a device for minimizing wine degradation in a wine bottle after being initially opened, said device comprising an outer flexible container that is open or openable along at least a portion of two opposed edge regions, said flexible container holding a wine protector member which in a first condition has an outer peripheral edge approximating internal cross-sectional dimensions of a body region of the wine bottle, said wine protector member being flexibly deformable to a second condition for introduction through a neck region of the wine bottle and once in said body region of the wine bottle is returned to said first condition to be located on a surface of wine in said body region, said wine protector member being characterized by being a multipart construction including a first flexible sheet material containing in a first zone, a plurality of individually substantially sealed spaces each having a volume and at least some of which contain a gas, and a second flexible sheet material, one or both of said first or said second flexible sheet materials having an outer peripheral edge extending radially beyond said first zone, at least one of said first or said second flexible sheet materials being substantially liquid and gas impervious, said wine protector member in use being rollable while within said outer flexible container about an axis extending between said two opposed edges for introduction into said opened wine bottle through one of said edge regions of said outer flexible container.

In certain preferred embodiments, said one of said two opposed edge regions has a length that is larger than a diameter of the outer peripheral edge of the wine protector member. This enables the wine protector member, in a rolled condition within the outer flexible container to fall from the container when the container is pushed through the neck region of the wine bottle. In a second possible configuration, a pair of edge regions of the flexible container joining said two opposed edge regions may converge from said one of said two opposed edge regions. In some aspects a rigid or semi-rigid pusher member may be connected with said flexible container. The pusher member may include an extendible portion movable between a first contracted condition and a second extended condition, said pusher member in said second extended condition extending beyond the edge region of the container opposite said one of said two opposed edge regions. The second extended condition of the pusher member allows the pusher member to be gripped to allow the container to be withdrawn from the wine bottle after the wine protector member has been deployed therein.

In accordance with certain aspects, the device disclosed may also include an elongated delivery member comprising a first grippable region and a second end region having two adjacent and spaced leg members whereby the leg members are positionable on opposed sides of the wine protector member within said container to enable the wine protector member to be rolled on itself within said container by rotating the delivery member about its elongate direction.

In certain embodiments there is also provided a delivery member for delivering a protector member, in use, through an open neck region of an opened bottle containing a liquid, said protector member being formed in a first condition with an outer peripheral edge approximating internal cross-sectional dimensions of a body region of the bottle, said protector member being flexibly deformable to a second condition for introduction through a neck region of the bottle and once in said body region of the bottle is returned to said first condition to be located on a surface of the liquid in said body region, said delivery member being elongated in form with a first grippable end region and a second opposed end region having two adjacent and spaced leg members whereby the leg members are positionable on opposed sides of the protector member to enable the protector member to be rolled on itself by rotating the delivery member about its elongate direction, said delivery member further including an intermediate region including seal means to engage with the neck region of the bottle to act as a stopper to minimize air ingress into the bottle.

In a certain further embodiment, there is provided a wine protector member, for use with wine remaining in a wine bottle after some wine has been dispensed therefrom, said wine protector member comprising a continuous sheet member having an outer peripheral edge approximating internal transverse cross-sectional dimensions of a body region of the wine bottle and being flexibly deformable into a second condition for introduction through a neck region of the wine bottle and once in said body region is returned to said first condition to be disposable on a surface of the wine in said wine bottle, said sheet member being substantially composed of a cork or a cork based material.

The wine protector member may have a peripheral outer edge region and a central inner zone, said peripheral outer region having a thickness approximately 25 to 50% of that of the central inner zone. In this way, the outer edge region can be more flexible than the inner zone so that the peripheral edge may contact the inner surface of the wine bottle without affecting the ability of the wine protector member to float on the wine surface during use. The central zone may have a thickness of 100 to 200 microns, preferably 150 microns and the peripheral outer region may have a thickness 30 to 80 microns, preferably 50 microns. The wine protector member may also include radial cuts extending inwardly from the outer peripheral edge, said radial cuts being circumferentially spaced along said outer peripheral edge. The cork or cork based material may be granulated cork (agglomerate cork) bonded to form said sheet member. Cork may be ground into small particles and then mixed with a range of possible bonding materials such as polyurethane, latex and wax. This mix may be mixed with a food grade adhesive and then injection moulded or extruded and compacted and it may be homogenised in a heat chamber.

The injection moulding of the protector member or the extrusion of a cylinder of such material from which protector members can be formed by a cutting or severing process may occur from a semi liquid pre-prepared mixture of such agglomerate cork material or may be carried out as a part of the process. Alternatively, a prepared sheet or roll of such agglomerate cork material may be utilized with the protector members being cut therefrom. The sheet or roll material may be preformed with circular thicker regions with thinner material formed therebetween such that the radial outer skirts of the protector members can be cut from the thinner sheet material surrounding circular thicker material zones to form a protector member as desired. The radial outer cuts may be formed simultaneously with or separate to the cutting of the sheet material to form the protector member.

In yet another embodiment, there is provided a wine protector member, for use with wine remaining in a wine bottle after some wine has been dispensed therefrom, said wine protector member comprising a core formed by a flexible and resilient cork or cork based material and outer layers of plastic film material sealed to one another around said core, said wine protector member having an outer peripheral edge approximating internal transverse cross-sectional dimensions of a body region of the wine bottle and being flexibly and resiliently deformable into a second condition for introduction through a neck region of the wine bottle and once in said body region is returned to said first condition by the resilience of said core to be disposable on a surface of the wine in said wine bottle. The core may be composed of at least one sheet member made of bonded granulated cork (agglomerate cork). The protector member may have a peripheral annular edge zone that is relatively more flexible than an inner zone containing the core. In this manner the outer peripheral edge may contact the inner surface of the wine bottle without affecting the ability of the wine protector to float on the wine surface during use.

### BRIEF DESCRIPTION OF THE DRAWINGS

Several preferred embodiments of the present invention will hereinafter be described with reference to the accompanying drawings, in which:

FIG. 1 is a schematic plan view of a certain embodiment of a protector member;

FIGS. 2a and 2b are schematic cross-sectional views taken along line II-II of FIG. 1 showing to different possible embodiments;

FIG. 3 is a schematic plan view of a certain further embodiment of a protector member;

FIGS. 4a and 4b are schematic cross-sectional views taken along line IV-IV of FIG. 3 showing two different possible embodiments;

FIG. 5 is a plan view of a further embodiment;

FIGS. 6a and 6b are section views along line VI-VI of FIG. 5 of two possible embodiments;

FIGS. 7, 8, 9 and 10 are schematic views showing a storage device for a protector member and a delivery device for introducing a protector member into an opened wine bottle in a sequence of process steps;

FIG. 11 is a schematic plan view showing a storage system capable of use in the introduction of a protector member into an opened wine bottle in accordance with certain embodiments;

FIG. 12 is a section view along line X-X of FIG. 11;

FIGS. 13a and 13b are views showing certain embodiments including an extendable pusher member in different positions;

FIG. 14 is a section view taken along line XII-XII of FIGS. 13a/13b;

FIG. 15 is a side view of a device for configuring and introducing a protector member into an opened wine bottle including a temporary stopper or seal region engageable with the neck of the bottle; and

FIG. 16 is a detailed side view showing an alternative arrangement for part of the device shown in FIG. 15.

A detailed description of certain preferred embodiments is set out in the following with particular reference to the annexed drawings, it being understood that the embodiments are illustrative in nature and should not be interpreted as limiting.

### DETAILED DESCRIPTION OF THE PREFERRED EMBODIMENTS

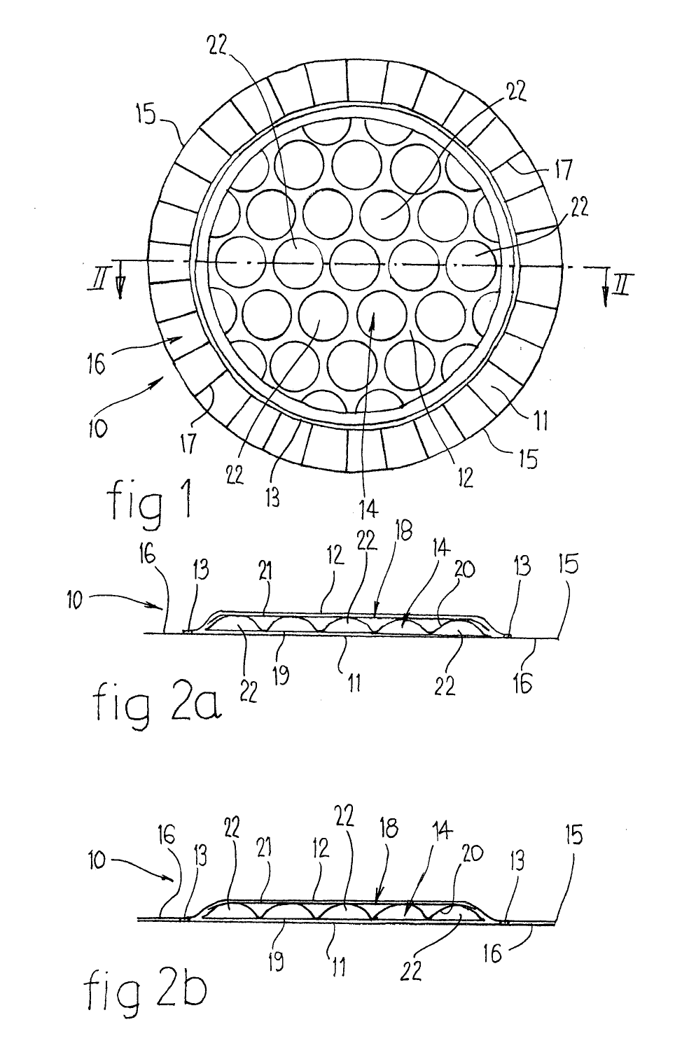

Referring to FIGS. 1, 2a and 2b, first preferred embodiments are illustrated of a wine protector member 10. The member 20 has a first outer layer 11 and a second outer layer 12 sealed to each other by a circumferential seal line 13 defining a contained sealed first zone 14. The layers 11, 12 may be of a plastics material film, such as polyethylene or any suitable plastics material that will not react with wine or the liquid that it is intended to be used with. The plastics material film may be heat sealable such that the seal line 13 is simply formed by a heat sealing operation. The plastics material film forming at least one of the layers 11, 12 is substantially gas impermeable and liquid impermeable. Both layers 11, 12 should be inert or non-reactable with wine or any other liquid the device may be used with. In use as described hereafter either of the layers 11, 12 could float on the wine surface remaining in an opened wine bottle. FIGS. 2a and 2b illustrate other embodiments. In FIG. 2a the layer 12 does not extend to the peripheral edge 15 of the member 10. In FIG. 2b, both layers 11 and 12 extend to the peripheral edge 15 of the member 10. In both embodiments, there is provided an outer peripheral zone 16 that is relatively more flexible than the first zone 14 of the member 10. Flexibility of the outer zone 16 may be increased by providing radial cuts or dividing lines 17 extending inwardly from the peripheral edge 15. The cuts or dividing lines 17 may extend fully through the outer zone 16 or may extend part way through this zone. The embodiment of FIG. 2b provides for the possibility that the radial cuts or dividing lines 17 in each of the layers 11, 12 within the peripheral zone 16 may be circumferentially offset from each other such that the cuts 17 in the layers 17 do not overlie one another. Further the peripheral edge 15 of the layers 11, 12 may have differing diameters such that the radially outer most part of the protector member 10 is made up of one film layer thickness only. The peripheral edge 15 may have a diameter that approximates the internal diameter of the body region of wine bottles such that the member 10 deployed correctly will span the surface of wine in the bottle after it has been opened and some wine has been dispensed. The diameter of the peripheral edge 15 may be slightly larger than the diameter of wine bottle body regions such that variations in the size of wine bottle body regions can be accommodated by the flexible nature of the outer zone 16 to ensure the peripheral outer edge remains in contact with the inner surface of the wine bottle.

Within the first zone 14 a further separate member 18 is provided having an outer dimension to approximate the peripheral dimensions of the first zone 14 but be contained therein. The member 14 is again made from plastics material film comprising two or three layers (as illustrated). With the three layer version, two outer layers 19 and 21 and an intermediate layer 20 are provided. In the two layer version one on the outer layers might be omitted. The intermediate layer 20 is sealed to one or both the outer layers 19, 21 to define individually sealed spaces or pockets 22. Some or all of the pockets 22 are filled with a gas (air or an inert gas such as nitrogen or argon) to provide sufficient buoyancy to the member 10 for it to float on the liquid in the bottle in use. Some of the pockets 22 may be filled with a liquid or gel to provide some weight to the member 10 to ensure it floats on the wine surface in the bottle and/or will correctly unroll or deploy in the bottle when introduced therein. If any of the pockets 22 are filled with a liquid or gel, it is desirable that the pockets 22 closer to the outer peripheral edge are so filled.

In another possible embodiment the inner member 18 represented in FIGS. 2a, 2b might be replaced by a cork or cork product layer such as a granulated bonded cork sheet member. Such a material has been found to have sufficient flexibility and resilience to allow the protector member to be rolled up for introduction through a bottle neck region and to unroll to deploy as required within the bottle.

The member 10 is sufficiently flexible so that it can be rolled up or folded on itself generally about a diametral line to a contracted condition sufficient to fit into and through a neck region of a wine bottle. The pockets 22, however, provide a degree of resilience or spring effect to ensure that once any constricting forces are removed the member 10 unrolls or unfolds to a flat or extended condition as represented in the drawings. This process occurs as a result of the materials from which the member 10 is constructed.

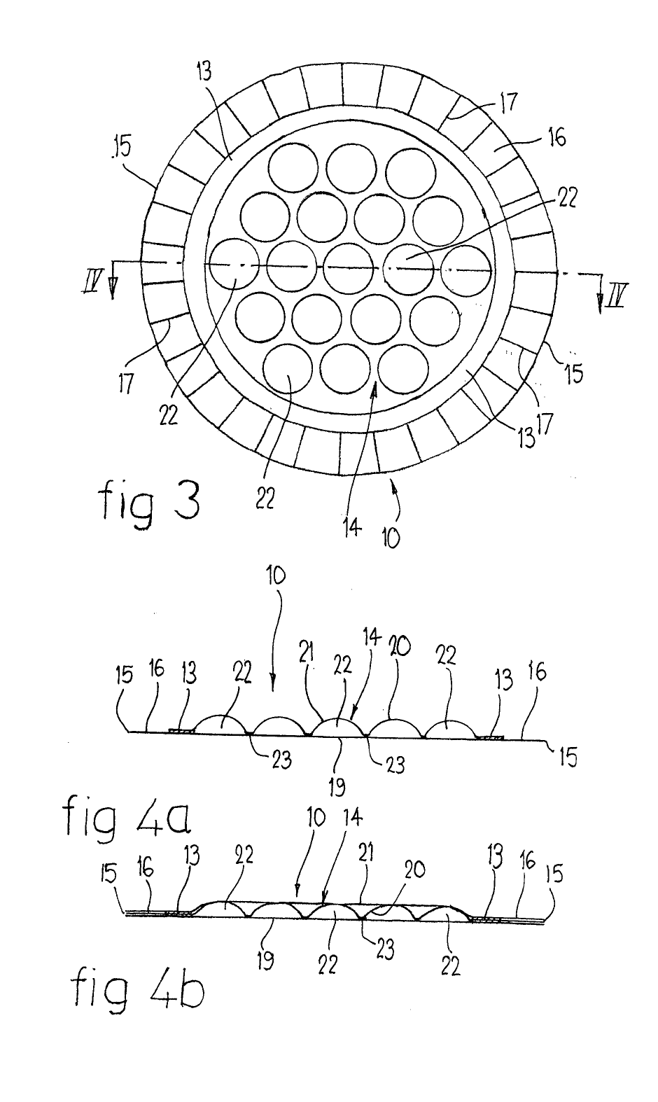

FIGS. 3, 4a and 4b show further embodiments of a wine protector device 10 similar to earlier drawing figures where like features have been given the same reference numbers. In these further embodiments, the first zone 14 and the individually sealed pockets 22 are formed as part of a plastics material layer also sealed at the peripheral seal line 13. In FIG. 4a, the member 10 is made from two layers 19, 20 with the layer 20 being sealed at the peripheral seal line 13 and internally as at 23 to the layer 19. In FIG. 4a three layers 19, 20, 21 are provided with all three layers sealed at 13 to one another. The individual pockets function similarly to the pockets 22 shown in FIGS. 1, 2a and 2b.

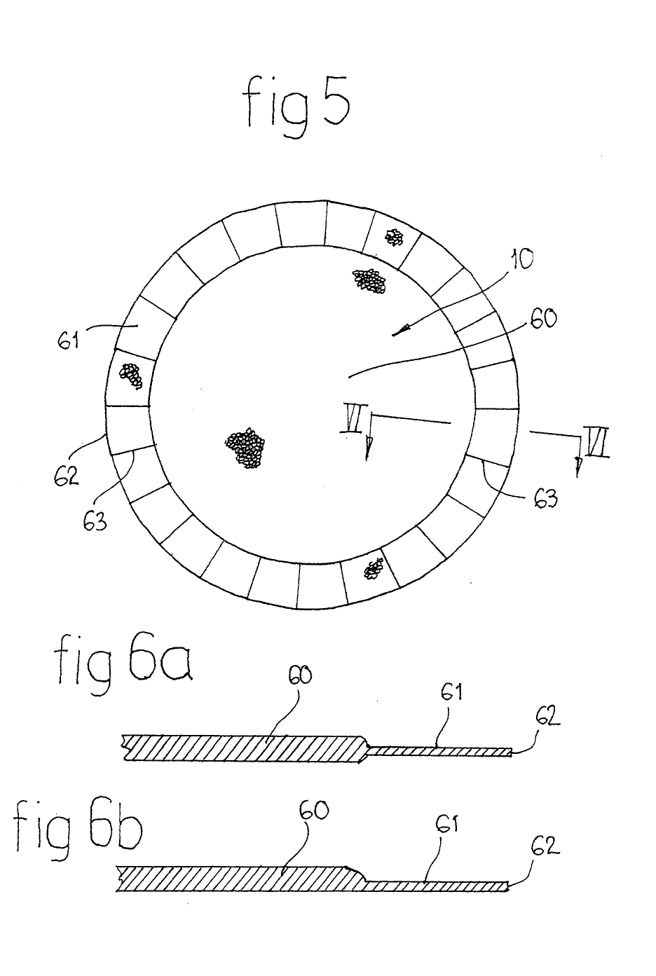

FIG. 5 illustrates in plan view another possible embodiment of a wine protector member 10 formed entirely from a cork product such as granulated bonded cork (agglomerate cork) formed into a sheet member. The protector member 10 has a central zone 60 and a surrounding annular zone 61 defining a laterally outer peripheral edge 62. The central zone 60 is conveniently thicker than the outer annular zone 61. Typically the central zone may be of the order of 150 microns thick while the outer annular zone 61 might be of the order of 50 microns thick whereby the outer annular zone has a significantly more flexible nature. This flexible nature is further enhanced by arranging a plurality of radially extending cuts 63 extending inwardly from the outer peripheral edge 62. The central zone 60 remains sufficiently flexible to allow it to be rolled on itself to be introduced through a narrow neck region of a wine bottle or similar bottle, but with sufficient inherent resilience to unroll once freed within the bottle to deploy on to the surface of wine or other liquid in the bottle. The material of the bonded granulated cork (agglomerate cork) has sufficient buoyancy to float on the liquid surface and sufficient resistance to penetration of gas and liquid to prevent same passing through the protector member 10 to a significant extent over the period of time whereby the protector member 10 might be used in a wine bottle after opening. The diameter of the outer peripheral edge 62 is selected to be just greater than the internal diameter of the body region of the wine bottle in which it might be used such that the edge 62 remains, in use, in contact with the inner surface of the wine bottle. The protector member 10 shown in FIGS. 5, 6a, 6b may be manufactured by grinding cork into very small particles, and then combining the small cork particles with a range of possible bonding materials such as polyurethane, latex and wax. This mix may be mixed with a food grade adhesive and then injection moulded or extruded and compacted and it may be homogenised in a heat chamber. The extruded granulated cork mixture may be sliced into layers of the material to form each protector member, the outer edge zone 61 being formed by pressing and cutting as a subsequent operation. Alternatively the product might be moulded individually in the shape illustrated. In either case the cuts 63 may be created thereafter as a secondary step. There may be additional processes used to treat the agglomerated cork to minimize the possibility of cork taint.

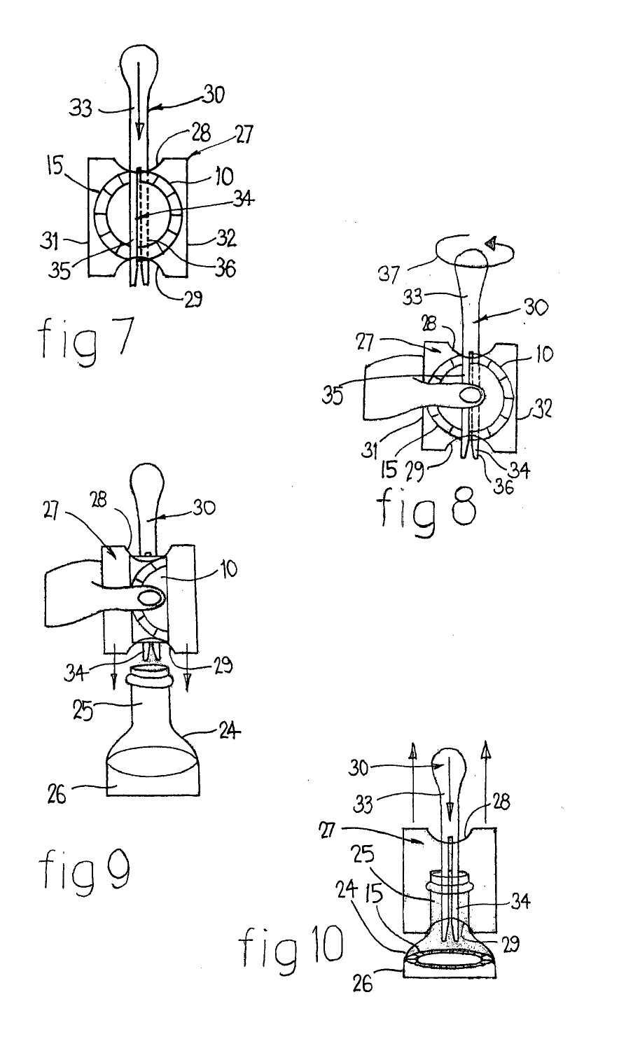

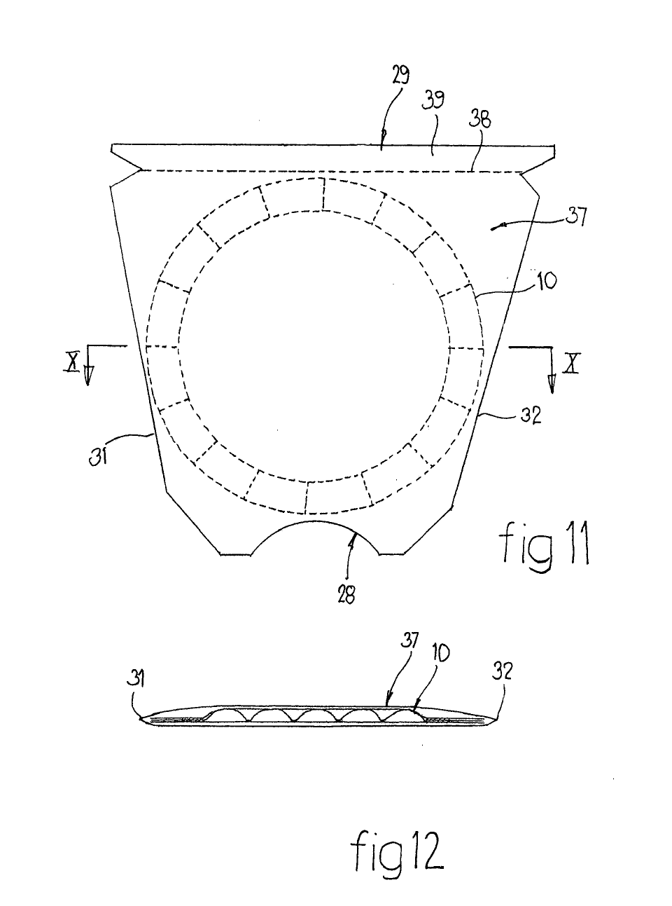

Referring now to FIGS. 7 to 10 various schematic views show in sequence a means and method for introducing a wine protector member 10 into an opened wine bottle 24 having a conventional neck region 25 and a body region 26. The wine protector member 10 is packed in an outer flexible container 27 having two opposed edges 28, 29 that are partially open or openable to allow a delivery device 30 to be passed therethrough. The edges 31, 32 joining the edges 28, 29 are closed to contain and protect the member 10 when stored in the container. The delivery device 30 has a first end region 33 that is grippable and a second end region 34 that is forked with two spaced legs 35, 36. The legs 35, 36 of the device 30 are passed through the opening in the edge 28 placing the legs 35, 36 diametrically across the member 10 and with a leg 35, 36 on either side of the member 10 within the container 27 (FIG. 7). In this condition a person can hold the container 27 (as shown in FIG. 8) while twisting the device 30 in the direction of the arrow 37 in FIG. 8. As a result the member 10 is rolled or folded on itself (FIG. 9) and in this condition the container edge 29 is placed over the neck region 25 of the bottle 24 (FIG. 9) and the device 30 is pushed downwardly to direct its end region 34 carrying the rolled member 10 into the bottle. Once the member 10 is in the bottle it will unroll when constraining forces are removed and deploy itself in a flat extended position as shown in FIG. 10. The device 30 is then withdrawn and the container 27 can be discarded. Once the member 10 is deployed in the bottle, it will float on the remaining wine surface with its peripheral edge 15 closely adjacent or engaging the wine bottle internal surface.

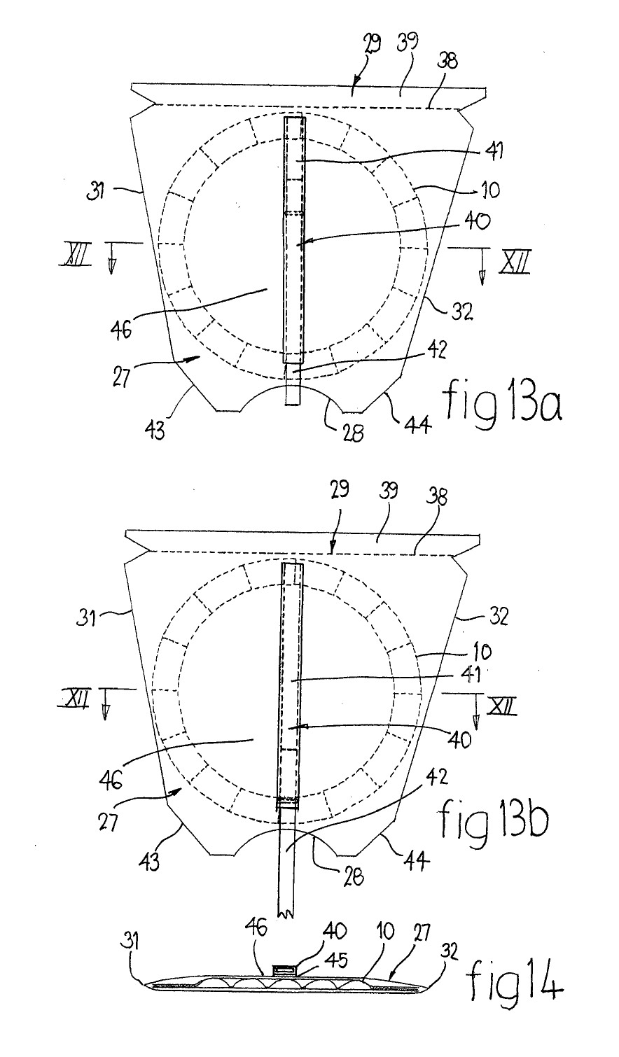

FIGS. 11, 12 illustrate certain embodiments of a wine protector member 10 held within an outer storage envelope or container 27. In this embodiment the opposed edges 28, 29 of the container 27 are closed to seal the member 10 within the container until it is to be deployed. The end edge 28 may include an at least partially openable section adjacent its mid zone to allow a forked delivery device 30 of the type generally shown in FIGS. 7 to 10 to be used. The other end of the container 27 includes a tear line 38 to assist tearing an end part 39 of the container to fully open the end edge 29. The closed edges 31, 32 diverge from the end edge 28 to the end edge 29. The material forming the container 27 may be relatively thin and flexible such as metalized foil or similar.

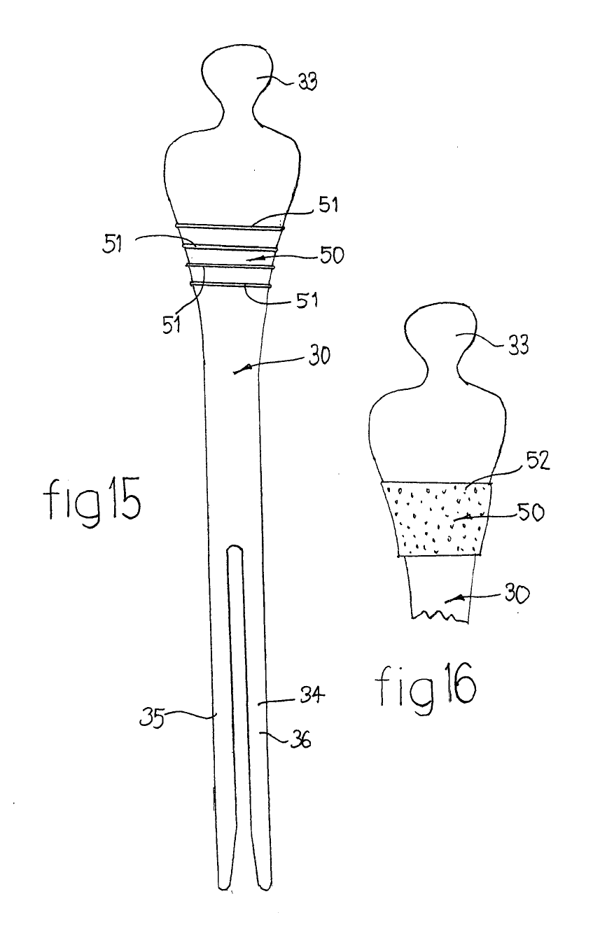

FIGS. 13a, 13b and 14 illustrate certain embodiments of a wine protector member 10 held within an outer storage envelope or container 27. In this further embodiment, a pusher member 40 is secured to the outer surface of the container 27. The pusher member 40 is rigid or semi-rigid and formed in two parts 41, 42 one 41 of which is secured to the container 27 and the other 42 is movable telescopically between an extended position (FIG. 13b) and a contracted position (FIG. 13a). Conveniently detent means 43 or similar is provided to hold the member 42 in the extended position for use as described hereafter. In use, the section 39 is removed by tearing along line 38 to fully open the end edge 29. Thereafter the container 27 is rolled up about the pusher member 40 to a size that will allow the container 27 and the member 10 to be introduced through the neck of the opened wine bottle. Once in the bottle and while holding the extended end 42 of the pusher member 40, the container 27 and member 10 unroll and the member 10 is free to drop out of the container 27 through the end edge 29. Thereafter the container 27 and pusher member 40 can be withdrawn from the bottle and to assist this process, chamfered or rounded corners 43, 44 are provided on the outer edges of container 27. Conveniently the pusher member 40 might be glued at 45 to the outer surface 46 of the container 27.

FIGS. 15, 16 illustrate a delivery device 30 of the type shown in FIGS. 7 to 10 which further includes an intermediate section 50 having a generally circular cross-section increasing in diameter from just below to just above that of the neck region 25 of the opened wine bottle 24. The section 50 may include integrally formed or separately formed seal rings 51 (FIG. 15) or a continuous seal material section 52 (FIG. 16). In these arrangements, the device 30 may be used to deliver the wine protector member 10 to the inside of the opened wine bottle and then also act as a temporary wine bottle stopper.

Various modifications within the scope of the annexed claims will be readily apparent to those skilled in this art. Furthermore, the annexed claims form part of the disclosure of this specification by this reference thereto.

1. A wine protector member adapted, for use with wine remaining in a wine bottle after some wine has been dispensed therefrom, said wine protector member being formed in a first condition with an outer peripheral edge approximating internal cross-sectional dimensions of a body region of the wine bottle, said protector member being flexibly deformable to a second condition for introduction through a neck region of the bottle and once in said body region of the wine bottle is returned to said first condition and is disposed on a surface of the wine remaining in said wine bottle, whereby air contact with the wine remaining in the wine bottle is restricted, said wine protector member being characterized by being a multipart construction including a first flexible sheet material containing in a first zone, a plurality of individually substantially sealed spaces each having a volume and at least some of which contain a gas, and a second flexible sheet material having portions sealed to said first flexible sheet material, one or both of said first or second flexible sheet materials having a radially outer edge forming the outer peripheral edge of said wine protector member, said radially outer edge extending radially beyond said first zone, at least one of said first or said second flexible sheet materials being substantially wine and gas impervious.

2. A wine protector member according to claim 1 wherein a third flexible sheet material is positioned over said first flexible sheet material and secured to:
(i) said first flexible sheet material; or
(ii) said second flexible sheet material; or
(iii) both said first and said second flexible sheet materials.

3. A wine protector member according to claim 2 wherein said third flexible sheet material is secured to said first flexible sheet material at each position defining a said sealed space.

4. A wine protector member according to claim 2 wherein both said second and said third flexible sheet materials are wine and gas impervious.

5. A wine protector member according to claim 4 wherein said first flexible sheet material is wine and gas impervious.

6. A wine protector member according to claim 1 wherein the first flexible sheet material is sealed to said second flexible sheet material generally about said first zone to form said first zone as a sealed space, said first zone containing said individually sealed spaces.

7. A wine protector member according to claim 6 wherein said individually sealed spaces are formed by at least two further flexible sheet material layers sealed to one another in a defined pattern.

8. A wine protector member according to claim 7 wherein said at least two further flexible sheet material layers are separate from and contained in said first zone between said first and said second flexible sheet materials.

9. A wine protector member according to claim 6 wherein both said first and said second flexible sheet materials are liquid and gas impervious.

10. A wine protector member according to claim 1 wherein said first and said second flexible sheet materials are heat sealable plastics material film.

11. A wine protector member according to claim 1 wherein the gas contained in at least some of said individually sealed spaces is air, or an inert gas including nitrogen or argon.

12. A wine protector member according to claim 11 wherein at least some of said individually sealed spaces include a liquid or gel.

13. A wine protector member according to claim 12 wherein the individually sealed spaces containing a liquid or gel are located at or adjacent to a peripheral region of the first zone.

14. A wine protector member according to claim 1 wherein an outer circumferential zone is provided radially outwardly of said first zone, said outer circumferential zone being relatively more flexible than said first zone.

15. A wine protector member according to claim 14 wherein said outer circumferential zone includes a plurality of dividing or separation lines extending inwardly from the outer peripheral edge.

16. A wine protector member according to claim 15 wherein each said dividing or separation line in one layer of a said flexible sheet material is covered by a portion of a further layer of a said flexible sheet material.

17. A device for minimizing wine degradation in a wine bottle after being initially opened, said device comprising an outer flexible container that is open or openable along at least a portion of two opposed edge regions, said flexible container holding a wine protector member which in a first condition has an outer peripheral edge approximating internal cross-sectional dimensions of a body region of the wine bottle, said wine protector member being flexibly deformable to a second condition for introduction through a neck region of the wine bottle and once in said body region of the wine bottle is returned to said first condition to be located on a surface of wine in said body region, said wine protector member, in use, being rollable while within said outer flexible container about an axis extending between said two opposed edge regions for introduction into said opened wine bottle through one of said edge regions of said outer flexible container.

18. A device for minimizing reaction of a liquid in a container having a narrow first neck region and a second wider body region with a gas after the container is initially opened, said device comprising an outer flexible holder that is open or openable along at least a portion of two opposed edge regions, said flexible holder holding a protector member which in a first condition has an outer peripheral edge approximating internal cross-sectional dimensions of said second wider body region of the container, said protector member being flexibly deformable to a second condition for introduction through the narrow first neck region of the container permitting the liquid to be dispensed therethrough and once in said second wider body region of the container is returned to said first condition to be located on a surface of the liquid in said container, said protector member being rollable while within said outer flexible holder into said second condition for introduction into said container through one of said edge regions of said outer flexible container and through said narrow first neck region of the container.

19. A device for minimizing wine degradation in a wine bottle after being initially opened, said device comprising an outer flexible container that is open or openable along at least a portion of two opposed edge regions, said flexible container holding a wine protector member which in a first condition has an outer peripheral edge approximating internal cross-sectional dimensions of a body region of the wine bottle, said wine protector member being flexibly deformable to a second condition for introduction through a neck region of the wine bottle and once In said body region of the wine bottle is returned to said first condition to be located on a surface of wine in said body region, said wine protector member being characterized by being a multipart construction including a first flexible sheet material containing In a first zone, a plurality of individually substantially sealed spaces each having a volume and at least some of which contain a gas, and a second flexible sheet material, one or both of said first or said second flexible sheet materials having an outer peripheral edge extending radially beyond said first zone, at least one of said first or said second flexible sheet materials being substantially liquid and gas impervious, said wine protector member in use being rollable while within said outer flexible container about an axis extending between said two opposed edges for introduction into said opened wine bottle through one of said edge regions of said outer flexible container.

20. A device according to claim 17 wherein said one of said two opposed edge regions is wider than a diameter of said wine protector member.

21. A device according to claim 20 wherein a second pair of edge regions of said container Joining said two opposed edge regions converge from said one of said two opposed edge regions.

22. A device according to claim 21 wherein a rigid or semi-rigid pusher member is connected with said container and extends parallel to said axis.

23. A device according to claim 22 wherein said pusher member includes an extendible portion movable between a first contracted condition and a second extended condition, said pusher member in said second extended condition extending beyond the edge region of said container opposite said one of said two opposed edge regions.

24. A device according to claim 17 wherein the device includes an elongated delivery member comprising a first grippable end region and a second end region having two adjacent and spaced leg members whereby the leg members are positionable on opposed sides of the wine protector member within said container to enable the wine protector member to be rolled on itself within said container by rotating the delivery member about its elongate direction.

25. A delivery member for delivering a protector member, in use, through an open neck region of an opened bottle containing a liquid, said protector member being formed in a first condition with an outer peripheral edge approximating internal cross-sectional dimensions of a body region of the bottle, said protector member being flexibly deformable to a second condition for introduction through a neck region of the bottle and once in said body region of the bottle is returned to said first condition to be located on a surface of the liquid in said body region, said delivery member being elongated in form with a first grippable end region and a second opposed end region having two adjacent and spaced leg members whereby the leg members are positionable on opposed sides of the protector member to enable the protector member to be rolled on itself by rotating the delivery member about its elongate direction, said delivery member further including an intermediate region including seal means to engage with the neck region of the bottle to act as a stopper to minimize air ingress into the bottle.

26. A wine protector member, for use with wine remaining in a wine bottle after some wine has been dispensed therefrom, said wine protector member comprising a continuous sheet member having an outer peripheral edge approximating internal transverse cross-sectional dimensions of a body region of the wine bottle and being flexibly deformable into a second condition for introduction through a neck region of the wine bottle and once in said body region is returned to said first condition to be disposable on a surface of the wine in said wine bottle, said sheet member being substantially composed of a cork or a cork based material.

27. A wine protector member according to claim 26 wherein the wine protector member has a peripheral outer edge region and a central inner zone, said peripheral outer region having a thickness approximately 25 to 50% of that of the central inner zone.

28. A wine protector member according to claim 26 wherein the central zone has a thickness of 100 to 200 microns and the peripheral outer region has a thickness of 30 to 80 microns.

29. A wine protector member according to claim 26 wherein radial cuts are formed extending inwardly from the outer peripheral edge, said radial cuts being circumferentially spaced along said outer peripheral edge.

30. A wine protector member according to claim 26 wherein the cork or cork based material is granulated cork bonded to form said sheet member.

31. A wine protector member, for use with wine remaining in a wine bottle after some wine has been dispensed therefrom, said wine protector member comprising a core formed by a flexible and resilient cork or cork based material and outer layers of plastic film material sealed to one another around said core, said wine protector member having an outer peripheral edge approximating internal transverse cross-sectional dimensions of a body region of the wine bottle and being flexibly and resiliently deformable into a second condition for introduction through a neck region of the wine bottle and once in said body region is returned to said first condition by the resilience of said core to be disposable on a surface of the wine in said wine bottle.

32. A wine protector member according to claim 31 wherein the core is comprised of at least one sheet member made of bonded granulated cork.

33. A wine protector member according to claim 31 wherein the protector member has a peripheral annular edge zone that is relatively more flexible than an inner zone containing said core.
